(19) United States
(12) Patent Application Publication
(10) Pub. No.: US 2026/0279238 A1
(43) Pub. Date: Sep. 17, 2026

(54) DISPLAY DRIVING DEVICE AND DISPLAY DRIVING METHOD THEREOF

(71) Applicant: BOE TECHNOLOGY GROUP CO., LTD., Beijing (CN)

(72) Inventors: Xitong MA, Beijing (CN); Ran DUAN, Beijing (CN)

(73) Assignee: BOE TECHNOLOGY GROUP CO., LTD., Beijing (CN)

(21) Appl. No.: 19/147,804

(22) PCT Filed: Aug. 12, 2024
(86) PCT No.: PCT/CN2024/111455

§ 371 Date: Jul. 14, 2025

(30) Foreign Application Priority Data
Sep. 1, 2023 (CN) 202311121220.5

(51) Int. Cl. G09G 3/20

(52) U.S. Cl. CPC G09G 3/20; G09G 2330/021; G09G 2340/0435

(57) ABSTRACT

The embodiment of the present disclosure relates to a display driving device and a display driving method. The display driving device comprises: a processor; a memory storing instructions which, when executed by the processor, configure the display driving device to: generate control data and input display data having a first frequency, wherein the input display data comprises first display data and second display data; perform a first format conversion on each of at least one first display data to generate at least one converted first display data; perform a second format conversion on each of at least one second display data to generate at least one converted second display data; combine the at least one converted first display data and the at least one converted second display data to generate output display data having the second frequency; and provide the output display data to the display screen for display.

### CROSS-REFERENCE TO RELATED APPLICATION

This patent application is a National Stage Entry of PCT/CN2024/111455 filed on Aug. 12, 2024, the disclosures of which is incorporated by reference herein in its entirety as part of the present application.

### TECHNICAL FIELD

The present disclosure relates to the field of display technology, and in particular, to a display driving device and a related display driving method and a related display system.

### BACKGROUND

At present, subarea display technology is used in many display systems, especially in vehicle-mounted display systems. In the subarea display technology, multiple display driving devices are provided in the display system to provide display data to each display area in a display screen. Providing display data by the multiple display driving devices increases demand for the display driving devices and their assembly space. Currently, a display system is proposed, which provides display data to a subarea display screen by a single display driving device. The system reduces the demand for display driving devices and can save assembly space for the display driving devices.

### SUMMARY

Embodiments of the present disclosure provide a display driving device and a related display driving method and a related display system.

A first aspect of the present disclosure provides a display driving device i. The display driving device comprises: a processor; and a memory storing instructions which, when executed by the processor, configure the display driving device to: provide control data and input display data having a first frequency, wherein the input display data comprises at least one first display data for displaying in at least one first display area of a display screen and at least one second display data for displaying in at least one second display area of the display screen, and the control data indicates that display data with a lower refresh rate is required for the at least one first display area and display data with a higher refresh rate is required for the at least one second display area; perform a first format conversion on the at least one first display data to generate at least one converted first display data having a second frequency; perform a second format conversion on the at least one second display data to generate at least one converted second display data having the second frequency; combine the at least one converted first display data and the at least one converted second display data to generate output display data having the second frequency; and provide the output display data to the display screen for displaying. The second frequency is N times the first frequency, wherein N is an integer greater than or equal to 2.

In an embodiment of the present disclosure, the display driving device is further configured to perform a first frame rate format conversion on the at least one first display data by replicating each frame of each first display data N times to generate the converted first display data.

In an embodiment of the present disclosure, the display driving device is further configured to perform the first format conversion on the at least one first display data by replicating each frame of each of the at least one first display data N times.

In an embodiment of the present disclosure, the display driving device is further configured to perform the second format conversion on the at least one second display data by dividing each frame of each of the at least one second display data into N frames.

In an embodiment of the present disclosure, the display driving device is further configured to the display driving device is further configured to combine the at least one converted first display data and the at least one converted second display data by performing, for the at least one converted first display data and the at least one converted second display data, the following operation: reading a frame of each of the at least one converted first display data and a corresponding frame of each of the at least one converted second display data sequentially to form a frame of the output display data.

In an embodiment of the present disclosure, the first frequency is 30 Hz and the second frequency is 60 Hz.

A second aspect of the present disclosure provides a display system. The display system comprises the display device according to the first aspect of the present disclosure.

In an embodiment of the present disclosure, the display system is mounted on a vehicle.

A third aspect of the present disclosure provides a display driving method. The method comprises: generating control data and input display data having a first frequency, wherein the input display data comprises at least one first display data for displaying in at least one first display area of a display screen and at least one second display data for displaying in at least one second display area of the display screen, and wherein the control data indicates that display data with a lower refresh rate is required for the at least one first display area and display data with a higher refresh rate is required for the at least one second display area; performing a first format conversion on the at least one first display data to generate at least one converted first display data having a second frequency; performing a second format conversion on the at least one second display data to generate at least one converted second display data having the second frequency; combining the at least one converted first display data and the at least one converted second display data to generate output display data having the second frequency; and providing the output display data to the display screen for displaying. The second frequency is N times the first frequency, and where N is an integer greater than or equal to 2.

In an embodiment of the present disclosure, performing the first format conversion on the at least one first display data comprises: replicating each frame of each of the at least one first display data N times.

In an embodiment of the present disclosure performing the second format conversion on the at least one second display data comprises: dividing each frame of each of the at least one second display data into N frames.

In an embodiment of the present disclosure, combining the at least one converted first display data and the at least one converted second display data comprises: performing, for the at least one converted first display data and the at least one converted second display data, the following operation: reading a frame of each of the at least one converted first display data and a corresponding frame of each of the at least one converted second display data sequentially to form a frame of the output display data.

### BRIEF DESCRIPTION OF THE DRAWINGS

In order to more clearly illustrate the technical solutions of the embodiments of the present disclosure, the drawings of the embodiments will be briefly described below. It should be noted that the drawings described below only relate to some embodiments of the present disclosure, rather than limiting the present disclosure. Throughout the various views of these drawings, corresponding reference numbers indicate corresponding components or features.

FIG. 1 shows a schematic diagram of a display system according to an embodiment of the present disclosure;

FIG. 2 shows a schematic flow chart of a display driving method according to an embodiment of the present disclosure;

FIG. 3 shows a schematic diagram of performing format conversion on input display data according to an embodiment of the present disclosure;

FIG. 4 shows a schematic diagram of combining converted first display data and converted second display data according to an embodiment of the present disclosure; and

FIG. 5 shows a schematic block diagram of a display driving device according to an embodiment of the present disclosure;

FIG. 6 shows a schematic block diagram of a display driving device according to another embodiment of the present disclosure;

FIG. 7 shows a schematic diagram of input display data and output display data according to an embodiment of the present disclosure; and

FIG. 8 shows a schematic diagram of input display data and output display data according embodiment of the present disclosure.

### DETAILED DESCRIPTION

In order to make the purpose, technical solution and advantages of the embodiments of the present disclosure clearer, the technical solution of the embodiments of the present disclosure will be clearly and completely described below in conjunction with the accompanying drawings. Obviously, the described embodiments are part of the embodiments of the present disclosure, rather than all of the embodiments. Based on the described embodiments of the present disclosure, all other embodiments obtained by those skilled in the art without creative work also fall within the scope of protection of the present disclosure.

When introducing elements of the present disclosure and embodiments thereof, the articles “a”, “an”, “the” and “said” are intended to indicate that there are one or more elements. The terms “comprising”, “including”, “containing” and “having” are intended to be inclusive and indicate that there may be additional elements other than the listed elements.

Unless otherwise defined, all terms (comprising technical and scientific terms) used herein have the same meanings as commonly understood by those skilled in the art to which the subject matter of the present disclosure belongs. It will be further understood that terms such as those defined in commonly used dictionaries should be interpreted as having meanings consistent with their meanings in the context of the specification and the relevant technology, and will not be interpreted in an idealized or overly formal form unless otherwise clearly defined herein. As used herein, a statement that two or more parts are “connected” or “coupled” together should refer to these parts being directly combined together or combined via one or more intermediate components. “Higher frequency” and “lower frequency” as used herein are relative, with the higher frequency being higher than the lower frequency.

In addition, terms such as “first” and “second” are used only to distinguish one component (or a part of the component) from another component (or another part of the component).

In prior art of providing the display data to the subarea display screen by the single display driving device, the display driving device generally generates and provides the display data with same higher frequency. However, in the subarea display, there may be a situation where a part of the display area requires the display data with a higher frequency, while another part of the display area requires the display data with a lower frequency. In this case, if the same higher frequency is used to generate the display data, high performance of the hardware resources of the display driving device is required, and the power consumption of the display system is high.

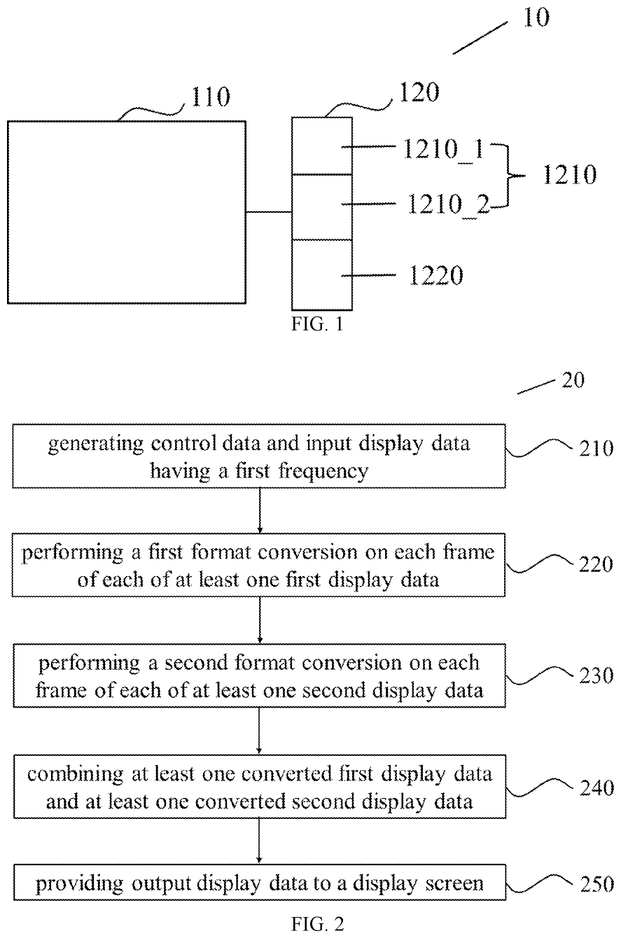

FIG. 1 shows a schematic block diagram of a display system 10 according to an embodiment of the present disclosure. As shown in FIG. 1, the display driving system 10 comprises a display driving device 110 and a display screen 120.

The display driving device 110 is coupled to the display screen 120 and is configured to provide output display data to the display screen 120 for displaying. In the embodiment of the present disclosure, the display driving device 110 may be configured to execute a display driving method as shown in FIG. 2.

The display screen 120 may comprise at least one first display area and at least one second display area, wherein the first display area requires display data with a lower refresh rate and the second display area requires display data with a higher refresh rate. In the example of FIG. 1, the display screen 120 comprises two first display areas 1210_1 and 1210_2 (collectively referred to as 1210) and a second display area 1220. The first display areas 1210_1 and 1210_2 require the display data with the lower refresh rate, while the second display area 1220 requires the display data with the higher refresh rate. For example, the display screen 120 may be a vehicle-mounted display screen having a resolution of 10796×1040 and two 2 EDP interfaces as input interfaces. The resolution and the frequence of the signal from each EDP interface may be 5248×1040 and 60 Hz, respectively. The first display area 1210_1 and 1210_2 may be an instrument area and a navigation area, respectively, with a resolution of 3498×1040 and a signal source with the lower refresh rate. The second display area 1220 may be an entertainment area, with a resolution of 3500×1040 and a signal source with the higher refresh rate.

Although in the example of FIG. 1, the display screen 120 is shown as comprising two first display areas and one second display area, it should be understood that the display screen 120 may also comprise other numbers of first display areas and second display areas. Moreover, the first display area 1210 and the second display area 1220 may be of other resolutions.

FIG. 2 shows a schematic flower chart of a display driving method 20 according to the embodiment of the present disclosure. The display driving method 20 may be executed by the display driving device 110 in FIG. 1 to drive the display screen 120 to display.

As shown in FIG. 2, in step 210, control data and input display data having a first frequency are provided. In an embodiment of the present disclosure, the control data may be used to indicate which display area that requires display data with the lower refresh rate and which display area that requires display data with a higher refresh rate. In an embodiment of the present disclosure, the control data may indicate that the first display area requires display data with the lower refresh rate, and the second display area requires display data with the higher refresh rate. In an embodiment of the present disclosure, the input display data may comprise at least one first display data for displaying in the at least one first display area of the display screen, and at least one second display data for displaying in the at least one second display area of the display screen. In the example of FIG. 1, the input display data Indata may comprise first display data data1_1 displayed in the first display area 1210_1, first display data data1_2 displayed in the first display area 1210_2, and second display data data2 displayed in the second display area 1220. Accordingly, one frame of the input display data Indata may comprise one frame of the first display data data1_1, one frame of the first display data data1_2, and one frame of the second display data data2. In addition, the input display data Indata has a first frequency f1, for example, 30 Hz. The control data may indicate that the first display area 1210 requires display data with the lower refresh rate, and the second display area 1220 requires display data with the higher refresh rate.

In step 220, a first format conversion is performed on each frame of each first display data in the at least one first display data. In an embodiment of the present disclosure, the converted first display data is generated by replicating each frame of each first display data N times, wherein N depends on the ratio of the second frequency to the first frequency of the output display data, and is a positive integer greater than or equal to 2. In the example of FIG. 1, assuming that the second frequency is 60 Hz, N is equal to 2. In this case, since the control data indicates that the first display area 1210 requires display data with the lower refresh rate, each frame of the first display data data1_1 and data1_2 having the first frequency f1 is replicated twice to generate the converted first display data data1′_1 and data1′_2 having the second frequency f2. In this way, the generated converted first display data data1′_1 and data1′_2 may comprise two frames identical to each frame of the first display data data1_1 and data1_2.

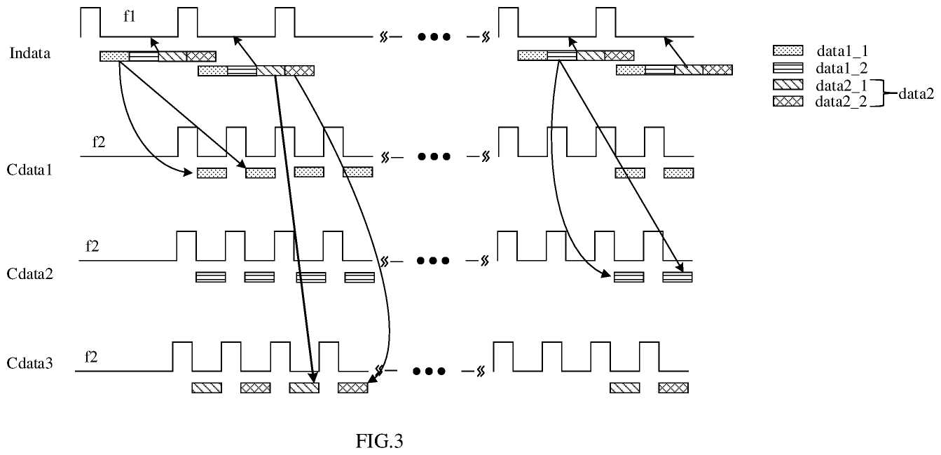

The conversion process for the first display data data1_1 and data1_2 is described below with reference to FIG. 3. As shown in FIG. 3, for the first display data data1_1, each frame thereof is replicated twice to generate two frames of the corresponding converted first display data data1′_1 having the second frequency f2. For the first display data data1_2, each frame thereof is also replicated twice to generate two frames of the corresponding converted first display data data1′_2 having the second frequency f2. In this step, each frame of the first display data data1_1 and data1_2 in the input display data Indata can be converted into two frames of the converted first display data data1′_1 and data1′_2, so that the converted first display data data1′ has a higher frequency than the input display data Indata.

In step 230, a second format conversion is performed on each frame of each second display data in at least one second display data. In an embodiment of the present disclosure, the converted second display data is generated by dividing each frame of each second display data into N frames. The format conversion process for the second display data will be described below with reference to FIG. 3.

As shown in FIG. 3, for the second display data data2, each frame thereof is divided to generate one frame of the converted second display data data2′_1 and one frame of the converted second display data data2′_2 having a second frequency f2. In this step, the second display data data2 in each frame of the input display data Indata can be converted into one frame of the converted second display data data2′_1 and one frame of the converted second display data data2′_2, so that the converted second display data data2′ has a higher frequency than the input display data Indata.

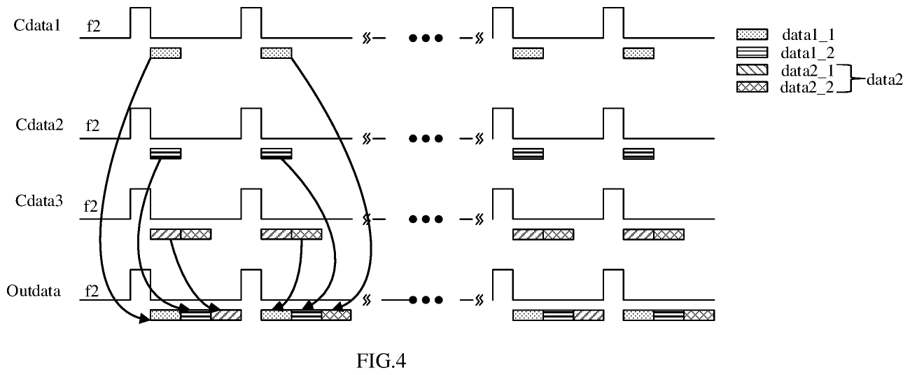

In step 240, at least one converted first display data and at least one converted second display data are combined. In an embodiment of the present disclosure, for at least one converted first display data and at least one converted second display data, the following operations are sequentially performed. One frame of each converted first display data and one frame of each converted second display data are read to form one frame of the output display data. The combining process is described below with reference to FIG. 4.

After the format conversion as described with reference to FIG. 3, each frame of the input display data Indata is converted into two frames of the converted first display data data1′_1, two frames of the converted first display data data1′_2, and two frames of the converted second display data data2′. As shown in FIG. 4, when performing combination, the first frame of the converted first display data data1′_1, the first frame of the converted first display data data1′_2, and the first frame data2′_1) of the converted second display data data2′ are read to form the first frame of the output display data Outdata. Then, the second frame of the converted first display data data1′_1, the second frame of the converted first display data data1′_2, and the second frame data2′_2) of the converted second display data data2′ are read to form the second frame of the output display data Outdata. The above process is repeated until the last frame of the converted first display data data1′ and the last frame of the converted second display data data2′, thereby generating the output display data Outdata. The output display data Outdata has the same second frequency f2 as the converted first display data data1′_1 and data1′_2 and the converted second display data data2′.

In step 250, the output display data is provided to the display screen for displaying. In an embodiment of the present disclosure, the output display data is transmitted to the display screen at the second frequency to drive the display screen for displaying.

Although the above description is made in detail with respect to an example in which the first frequency f1=30 Hz and the second frequency f2=60 Hz (and therefore N=2), it should be understood that the first frequency f1 and the second frequency f2 may also take other values.

By using the display driving method and the display driving system according to the embodiments of the present disclosure, the input display data can be generated at the lower frequency, and different frame rate processing can be performed on the input display data by areas based on the characteristics of the display area of the display screen, thereby reducing the requirements on the performance of the hardware and power consumption.

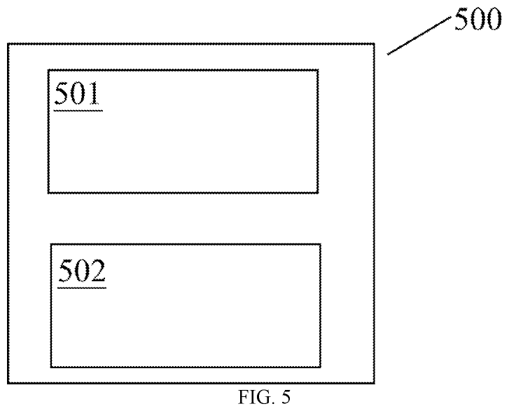

FIG. 5 shows a schematic block diagram of a display driving device 500 according to an embodiment of the present disclosure. As shown in FIG. 5, the display driving device 500 may comprise a processor 501 and a memory 502 coupled to the processor 501. The display driving device 500 may be coupled to an external display screen to provide the output display data thereto for displaying. The memory 502 stores instructions, which, when executed by the processor 501, may configure the display driving device 500 to perform the display driving method described in detail above with reference to FIGS. 2 to 4, the description of which will be omit.

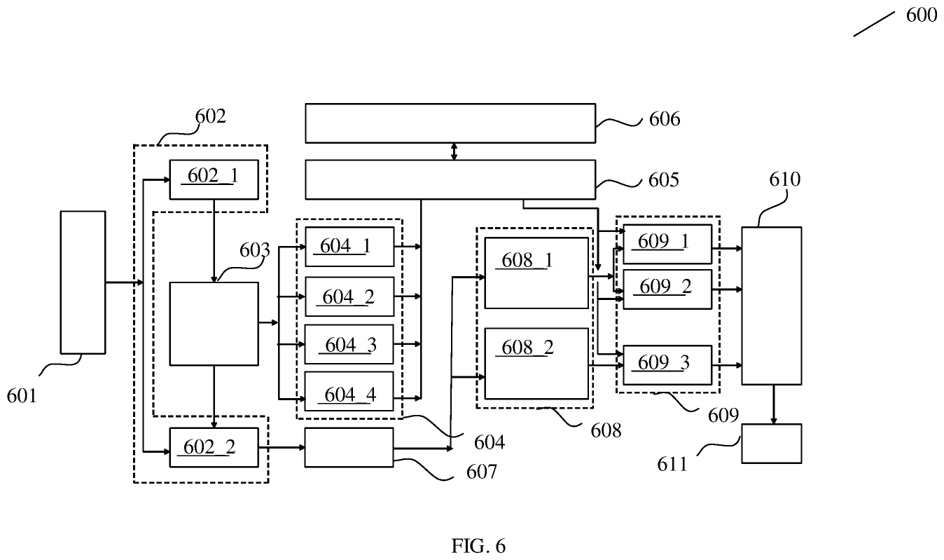

FIG. 6 shows a schematic block diagram of a display driving device 600 according to another embodiment of the present disclosure. In FIG. 6, the display driving device 600 may comprise a data generating module 601, a receiving module 602, a dividing module 603, a writing module 604, an arbitration module 605, a storage module 606, a timing generating module 607, a control module 608, a reading module 609, a combining module 610, and an output module 611.

The data generating module 601 may be coupled to the receiving module 602 and configured to generate the input display data and the control data, and transmit the input display data and the control data to the receiving module 602, wherein the data generating module 601 transmits the input display data at the first frequency. In an embodiment of the present disclosure, the data generating module 601 may be implemented using a system on a chip (SOC). As an example, the data generating module 601 may have a higher-definition multimedia interface that can transmit display data with a resolution of 7,680×4,320 at the frequency of 30 Hz. In an example, the input display data comprises the first display data data1_1 and data1_2 for two first display areas and the second display data data2 for the second display area. The control data indicates that the first display area requires display data with the lower refresh rate, and the second display area requires display data with the higher refresh rate.

The receiving module 602 may be coupled to the data generating module 601, the dividing module 603 and the timing generating module 607, and is configured to receive the input display data and the control data having the first frequency from the data generating module 601, provide the input display data to the dividing module 603, and provide the control data to the timing generating module 607. Further, the receiving module 602 may comprise a display data receiving module 602_1 and a control data receiving module 602_2. The display data receiving module 602_1 may be coupled to the dividing module 603, and is configured to receive the input display data from the data generating module 601, and provide the input display data to the dividing module 603. The control data receiving module 602_2 may be coupled to the timing generating module 607, and is configured to receive the control data from the data generating module 601, and provide the control data to the timing generating module 607.

The dividing module 603 may be coupled to the receiving module 602 and the writing module 604, and is configured to divide the received input display data based on predetermined format. For the above example, the dividing module 603 divides the input display data into the first display data data_1, the first display data data1_2, the first part data2_1 of the second display data data2, and the second part data2_2 of the second display data data2. The divided display data is written into the storage module 620 via the writing module 604 under the control of the arbitration module 612.

The arbitration module 605 may be coupled to the writing module 604, the storage module 606 and the reading module 609, and is configured to control access order of the writing module 604 and the reading module 609 to the storage module 606. In the embodiment of the present disclosure, the arbitration module 605 controls the reading module 609 to read the corresponding display data from the storage module 606 after the writing module 604 writes the divided display data into the storage module 606.

The writing module 604 may be coupled to the storage module 606 and configured to write the divided display data into the storage module 606. For the above example, further, the writing module 604 may comprise a first writing submodule 604_1, a second writing submodule 604_2, a third writing submodule 604_3 and a fourth writing submodule 604_4. The first writing submodule 604_1 is configured to receive the first display data data1_1 and write it into the storage module 606. The second writing submodule 604_2 is configured to receive the first display data data1_2 and write it into the storage module 606. The third writing submodule 604_3 is configured to receive the first part data2_1 of the second display data data2 and write it into the storage module 606. The fourth writing submodule 604_4 is configured to receive the second part data2_2 of the second display data data2 and write it into the storage module 606. As an example, the writing submodules 604_1, 604_2, 604_3 and 604_4 may be wavelength division multiple access WDMA modules. Although in this example, the writing module 604 comprises four writing submodules corresponding to the first display data data1_1 and data1_2 and the two parts data2_1 and data2_2 of the second display data data2, respectively. It should be understood that the writing module may also comprise other numbers of writing submodules.

The storage module 606 is coupled to the reading module 609 and is configured to store the display data written by the writing module 604. For the above example, the storage module 606 can store the written display data data1_1, data1_2, data2_1 and data2_2 in four independent storage spaces respectively.

The timing generating module 607 may be coupled to the receiving module 602 (particularly, a control data receiving module 602) and the control module 608, and is configured to generate a timing signal having a second frequency f2, and provide the generated timing signal and the received control data to the control module 608.

The control module 608 may be coupled to the timing generating module 607 and the reading module 609, and is configured to generate a readout frame synchronization signal based on the received control data and the timing signal, and provide the readout frame synchronization signal to the reading module 609. For the above example, the control module 608 comprises a first control submodule 608_1 and a second control submodule 608_2. The first control submodule 608_1 is configured to generate a first readout frame synchronization signal for the first display data based on the control data indicating that the first display area requires the timing signal and display data with the lower refresh rate, and provide the first control signal to the reading module 609. The second control submodule 608_2 is configured to generate a second readout frame synchronization signal for the second display data based on the control data indicating that the second display area requires the timing signal and display data with the higher refresh rate, and provide the second control signal to the reading module 609.

The reading module 609 may be coupled to the storage module 606, the control module 608 and the combining module 610, and is configured to read the first display data and the second display data from the storage module 606 based on the readout frame synchronization signal from the control module 608. For the above example, the reading module 609 may comprise a first reading submodule 609_1, a second reading submodule 609_2, and a third reading submodule 609_3. The first reading submodule 609_1 is configured to read the first display data data1_1 from the storage module 606 based on the first control signal from the first control submodule 608_1, and read each frame twice to obtain the converted first display data data1′_1 having the second frequency f2, and then sequentially provide the converted first display data data1′_1 to the combining module 610. The second reading submodule 609_2 is configured to read the first display data data1_2 from the storage module 606 based on the first control signal from the first control submodule 608_1, and reads each frame twice to obtain the converted first display data data1′_2 having the second frequency f2, and then sequentially provide the converted first display data data1′_2 to the combining module 610. The third reading submodule 609_3 reads each frame of the second display data data2 from the storage module 606 based on the second control signal from the second control submodule 608_2, and then sequentially provides the converted second display data data2′ to the combining module 610. Although in this example, the reading module 609 comprises four reading submodules corresponding to the first display data data1_1 and data1_2 and the two parts data2_1 and data2_2 of the second display data data2, respectively. It should be understood that the reading module may also comprise other numbers of writing submodules.

The combining module 610 can be coupled to the reading module 609 and the output module 645, and is configured to combine the received converted first display data and the received converted second display data to generate the output display data. For the above example, the combining module 610 is configured to combine the following data to form one frame of the output display data Outdata, and provide the frame to the output module 645: one frame of the received converted first display data data1′_1, one frame of the converted first display data data1′_2, and one frame of the converted second display data data2′_1. Then, the combining module 610 is configured to combine the following data to form another one frame of the output display data Outdata, and provide the frame to the output module 645: another one frame of the received converted first display data data1′_1, another one frame of the converted first display data data1′_2, and one frame of the converted second display data data2′_2. The above process is repeated until all the input display data stored in the storage module 606 are converted into the output display data, and the output display data is provided to the display screen 120.

The output module 611 may be coupled to the combining module 610 and the display screen 120, and is configured to provide the received output display data to the display screen 120. In this example, the output module 611 comprises two EDP interfaces, which may be coupled to two EDP interfaces of the display screen 120. Since the maximum resolution of data transmitted by the EDP interface is 5248×1040 and the frequency is 60 Hz, the output display data with a resolution of 10496×1040 for the display screen may be divided into two appropriate parts (for example, two parts with a resolution of 5249×1040) and transmitted at a frequency of 60 Hz.

Alternatively, in the embodiment of the present disclosure, the display driving device 600 may not comprise the storage module 606 and the arbitration module 605. In this case, the writing module 604 may directly provide the corresponding input display data to the reading module 609, and then the reading module 609 provides the generated output display data to the display screen 120.

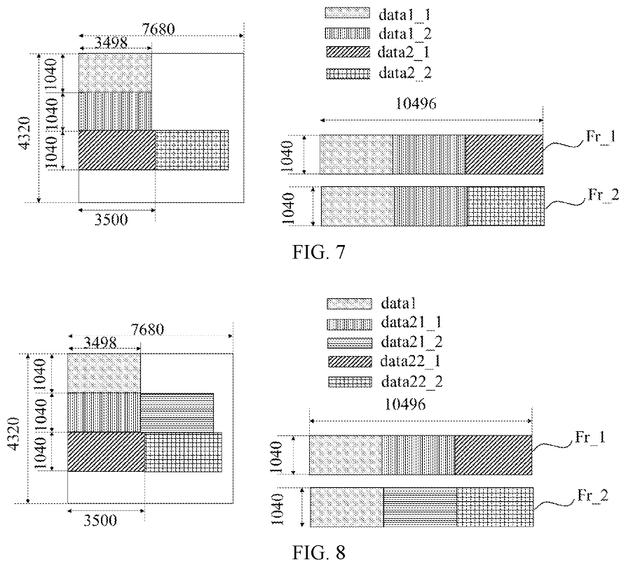

FIG. 7 shows a schematic diagram of input display data and output display data according to an embodiment of the present disclosure. In this example, the display screen is the display screen 120 in FIG. 1. The maximum resolution of the input display data is 7680×4320, and the resolution of the output display data is 10496×1040. One frame of the input display data comprises one frame of the first display data data1_1 and one frame of the first display data data1_2 for the first display area 1210, and one frame of the second display data data2 for the second display area 1220. Similar to the above description with reference to FIGS. 3 and 4, a first format conversion is performed on each frame of the first display data data1_1 to generate two frames of the converted first display data data1′_1. The first format conversion is also performed on each frame of the first display data data1_2 to generate two frames of the converted first display data data1′_2. A second format conversion is performed on each frame of the second display data data2 to generate one frame of the converted second display data data2′_1 and one frame of the converted second display data data2′_2. The output display data Outdata comprises two frames Fr_1 and Fr_2. The frame Fr_1 comprises one frame of the converted first display data data1′_1, one frame of the converted first display data data1′_2, and one frame of the converted second display data data2′_1. The frame Fr_2 comprises one frame of the converted first display data data1′_1, one frame of the other converted first display data data1′_2, and one frame of the converted second display data data2′_2. In this example, the resolution of the first display data data1_1 is 3498×1040, and the resolution of the first display data data1_2 is 3498×1040. The resolution of the second display data data2_1 or data2_2 is 3450×1040.

FIG. 8 shows a schematic diagram of input display data and output display data according to another embodiment of the present invention. Different from FIG. 7, in this example, the display screen has one first display area 1210 and two second display areas 1220. As shown in FIG. 8, one frame of the input display data comprises one frame of the first display data data1 for the first display area 1210; one frame of the second display data data21 for the second display area 1220_1 which comprises one frame of the second display data data21_1 and one frame of the second display data data21_2; and one frame of the second display data data22 for the second display area 1220_2 which comprises one frame of second display data data22_1 and one frame of second display data data22_2. Similar to the above description with reference to FIGS. 3 and 4, the first format conversion is performed on each frame of the first display data data1 to generate two frames of the converted first display data data1′. The second format conversion is performed on each frame of the second display data data21 to generate one frame of the converted second display data data21′_1 and one frame of the converted second display data data21′_2. The second format conversion is performed on each frame of the second display data data22 to generate one frame of the converted second display data data22′_1 and one frame of the converted second display data data22′_2. The output display data comprises two frames Fr_1 and Fr_2. The frame Fr_1 comprises one frame of the converted first display data data1′, one frame of the converted second display data data21′_1, and one frame of the another converted second display data data22′_1. The frame Fr_2 comprises one frame of the converted first display data data1′, one frame of the converted second display data data21′_2, and one frame of another converted second display data data22′_2.

Several embodiments of the present disclosure have been described herein in detail, but these embodiments are presented by way of example only and are not intended to limit the scope of the present disclosure. In fact, the novel embodiments described herein may be implemented in various other forms. In addition, various omissions, replacements, and modifications in the form of the embodiments described herein may be made without departing from the spirit of the present disclosure. The appended claims and their equivalents are intended to cover such forms or modifications that fall within the scope and spirit of the present disclosure.

1. A display driving device, comprising:
a processor; and
a memory storing instructions which, when executed by the processor, configure the display driving device to:
provide control data and input display data having a first frequency, wherein the input display data comprises at least one first display data for displaying in at least one first display area of a display screen and at least one second display data for displaying in at least one second display area of the display screen, and wherein the control data indicates that display data with a lower refresh rate is required for the at least one first display area and display data with a higher refresh rate is required for the at least one second display area;
perform a first format conversion on the at least one first display data to generate at least one converted first display data having a second frequency;
perform a second format conversion on the at least one second display data to generate at least one converted second display data having the second frequency;
combine the at least one converted first display data and the at least one converted second display data to generate output display data having the second frequency; and
provide the output display data to the display screen for displaying;
wherein the second frequency is N times the first frequency, and N is an integer greater than or equal to 2.

2. The display driving device according to claim 1, wherein the display driving device is further configured to perform the first format conversion on the at least one first display data by:
replicating each frame of each of the at least one first display data N times.

3. The display driving device according to claim 2, wherein the display driving device is further configured to perform the second format conversion on the at least one second display data by:
dividing each frame of each of the at least one second display data into N frames.

4. The display driving device according to claim 3, wherein the display driving device is further configured to combine the at least one converted first display data and the at least one converted second display data by:
performing, for the at least one converted first display data and the at least one converted second display data, the following operation:
reading a frame of each of the at least one converted first display data and a corresponding frame of each of the at least one converted second display data sequentially to form a frame of the output display data.

5. The display driving device according to claim 1, wherein the first frequency is 30 Hz and the second frequency is 60 Hz.

6. A display system comprising a display driving device according to claim 1 and a display screen.

7. The display system according to claim 6, which is mounted on a vehicle.

8. A display driving method, comprising:
generating control data and input display data having a first frequency, wherein the input display data comprises at least one first display data for displaying in at least one first display area of a display screen and at least one second display data for displaying in at least one second display area of the display screen, and wherein the control data indicates that display data with a lower refresh rate is required for the at least one first display area and display data with a higher refresh rate is required for the at least one second display area;
performing a first format conversion on the at least one first display data to generate at least one converted first display data having a second frequency;
performing a second format conversion on the at least one second display data to generate at least one converted second display data having the second frequency;
combining the at least one converted first display data and the at least one converted second display data to generate output display data having the second frequency; and
providing the output display data to the display screen for displaying;
wherein the second frequency is N times the first frequency, and where N is an integer greater than or equal to 2.

9. The display driving method according to claim 8, wherein performing the first format conversion on the at least one first display data comprises:
replicating each frame of each of the at least one first display data N times.

10. The display driving method according to claim 9, wherein performing the second format conversion on the at least one second display data comprises:
dividing each frame of each of the at least one second display data into N frames.

11. The display driving method according to claim 10, wherein combining the at least one converted first display data and the at least one converted second display data comprises:
performing, for the at least one converted first display data and the at least one converted second display data, the following operation:
reading a frame of each of the at least one converted first display data and a corresponding frame of each of the at least one converted second display data sequentially to form a frame of the output display data.

12. The display driving method according to claim 8, wherein the first frequency is 30 Hz, and the second frequency is 60 Hz.

13. The display system according to claim 6, wherein the display driving device is further configured to perform the first format conversion on the at least one first display data by:
replicating each frame of each of the at least one first display data N times.

14. The display system according to claim 13, wherein the display driving device is further configured to perform the second format conversion on the at least one second display data by:
dividing each frame of each of the at least one second display data into N frames.

15. The display system according to claim 14, wherein the display driving device is further configured to combine the at least one converted first display data and the at least one converted second display data by:
performing, for the at least one converted first display data and the at least one converted second display data, the following operation:
reading a frame of each of the at least one converted first display data and a corresponding frame of each of the at least one converted second display data sequentially to form a frame of the output display data.

16. The display system according to claim 6, wherein the first frequency is 30 Hz and the second frequency is 60 Hz.

17. The display driving method according to claim 5, wherein the display driving device is further configured to perform the first format conversion on the at least one first display data by:
replicating each frame of each of the at least one first display data N times.

18. The display driving method according to claim 17, wherein the display driving device is further configured to perform the second format conversion on the at least one second display data by:
dividing each frame of each of the at least one second display data into N frames.

19. The display driving method according to claim 18, wherein the display driving device is further configured to combine the at least one converted first display data and the at least one converted second display data by:
performing, for the at least one converted first display data and the at least one converted second display data, the following operation:
reading a frame of each of the at least one converted first display data and a corresponding frame of each of the at least one converted second display data sequentially to form a frame of the output display data.

20. The display driving method according to claim 12, wherein performing the first format conversion on the at least one first display data comprises:
replicating each frame of each of the at least one first display data N times.
